(19) United States
(12) Patent Application Publication
(10) Pub. No.: US 2020/0364040 A1
(43) Pub. Date: Nov. 19, 2020

(54) System and Method for Restoring a Previously Functional Firmware Image on a Non-Volatile Dual Inline Memory Module

(71) Applicant: DELL PRODUCTS, LP, Round Rock, TX (US)

(72) Inventors: Ching-Lung Chao, Austin, TX (US); Shih-Hao Wang, New Taipei (TW); Hung-Tah Wei, Round Rock, TX (US); Hsin-Chieh Wang, Taoyuan City (TW)

(21) Appl. No.: 16/415,432

(22) Filed: May 17, 2019

(51) Int. Cl. G06F 8/65; G06F 13/16; G06F 13/42; G06F 3/06; G06F 9/445

(52) U.S. Cl. CPC G06F 8/65; G06F 13/1668; G06F 13/4282; G06F 9/44536; G06F 3/0659; G06F 3/0679; G06F 3/0604

(57) ABSTRACT

A non-volatile dual in-line memory module (NVDIMM) includes a Serial Presence Interface (SPI) read only memory (ROM) device, and a non-volatile memory device. A firmware updater stores a first firmware image for the NVDIMM to the SPI ROM device, and stores the firmware image to the non-volatile memory device.

### FIELD OF THE DISCLOSURE

The present disclosure generally relates to information handling systems, and more particularly relates to restoring a previously functional firmware image on a non-volatile dual inline memory module.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may include a non-volatile dual in-line memory module (NVDIMM) having a Serial Presence Interface (SPI) read only memory (ROM) device, and a non-volatile memory device. A processor may execute a firmware updater to store a first firmware image for the NVDIMM to the SPI ROM device, and store the firmware image to the non-volatile memory device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of an information handling system according to at least one embodiment of the disclosure;

FIG. 2 is a phase diagram for a UEFI boot of the information handling system according to at least one embodiment of the disclosure;

FIG. 3 is a block diagram of another portion of an information handling system according to at least one embodiment of the disclosure;

FIG. 4 is a memory map illustrating a memory partition of a NVDIMM according to at least one embodiment of the disclosure;

FIG. 5 illustrates an OEM region of the memory map of FIG. 4;

FIG. 6 is a flow diagram illustrating a method for restoring a previously functional firmware image on an NVDIMM according to at least one embodiment of the disclosure; and

FIG. 7 is a block diagram of a general information handling system according to at least one embodiment of the disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

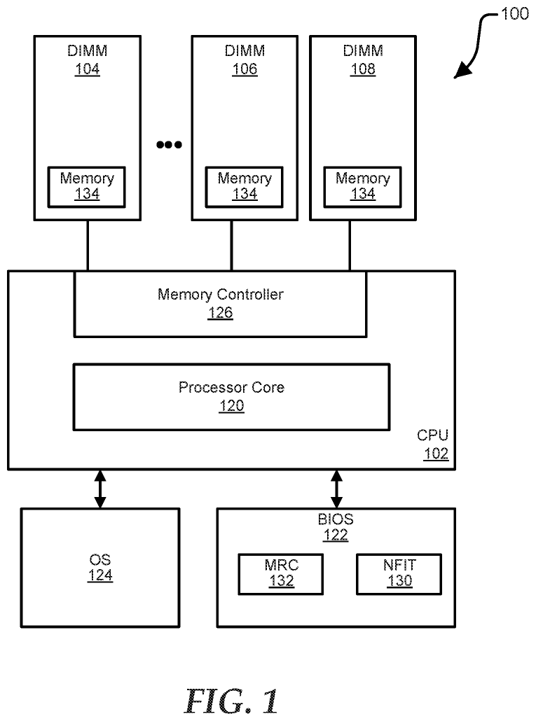

FIG. 1 shows a portion of an information handling system 100, including a CPU or processor 102, and dual in-line memory modules (DIMMs) 104, 106, and 108. CPU 102 includes a processor core 120 and a memory controller 126. CPU 102 executes code to implement a basic input/output system (BIOS) 122, and upon completion of a boot process of the BIOS, executes an operating system (OS) 124. BIOS 122 represents firmware code utilized during the boot process to execute a power-on self-test (POST), to initialize the hardware components of information handling system 100, and to pass execution to OS 124. For example, the hardware components of information handling system 100 initialized by BIOS 122 may include, but are not limited to, CPU 102 and DIMMs 104, 106, and 108. BIOS 122 also represents firmware code to provide runtime services for OS 124 and other programs executed by CPU 102. BIOS 122 includes a non-volatile dual in-line memory module (NVDIMM) firmware interface table (NFIT) 130, and memory reference code (MRC) 132. NFIT 130 stores information including, but not limited to, persistent memory ranges and properties for DIMMs 104, 106, and 108 configured as Persistent Memory.

DIMMS 104, 106, and 108 represent DIMMs that make one or more types of memory 134 accessible to CPU 102 for data storage. For example, DIMMs 104, 106, and 108 may include dynamic random access memory (DRAM), flash memory storage, NVDIMM storage, or other types of storage, as needed or desired. When one or more of DIMMs 104, 106, or 108 represents NVDIMM storage, the NVDIMM storage may include: NVDIMM-F having only persistent memory, such as flash storage; NVDIMM-N having both flash storage and DRAM on the same memory module; NVDIMM-P having persistent DRAM; and NVDIMM-X having NAND flash storage and DRAM on the same memory module. In a particular embodiment, one or more of DIMMs 104, 106, and 108 represent NVDIMMs that utilize Intel Optane DC Persistent Memory Modules (Apache Pass (AEP)) DIMMs with memory 134 configured according to one of the memory types stated above, such as NVDIMM-F. One of ordinary skill in the art will recognize that while FIG. 1 illustrates DIMMs 104, 106, and 108, this disclosure is not limited to three DIMMs but can be applied to any number of DIMMs, as indicated by the ellipses in between DIMMs 104 and 106. In an embodiment, one or more of DIMMs 104, 106, and 108 may include additional components (not shown), without varying from the scope of this disclosure.

CPU 102 provides the data processing functionality of information handling system 100, such as is typically associated with an information handling system. As such, CPU 102 represents a data processing apparatus, such as one or more processor cores, and the associated data input and output (I/O) functionality, such as a chipset component, and other I/O processor components. CPU 102 operates to execute machine-executable code to perform the data processing tasks associated with information handling system 100.

BIOS 122 can be referred to as a firmware image, and the term BIOS is herein used interchangeably with the term firmware image, or simply firmware. BIOS 122 includes instructions executable by CPU 102 to initialize and test the hardware components of system 100, and to load a boot loader or OS 124 from a mass storage device. BIOS 122 additionally provides an abstraction layer for the hardware, i.e. a consistent way for application programs and operating systems to interact with the keyboard, display, and other input/output devices. When power is first applied to information handling system 100, the information handling system begins a sequence of initialization procedures. During the initialization sequence, also referred to as a boot sequence, components of information handling system 100 are configured and enabled for operation, and device drivers for the components is installed. Device drivers provide an interface through which other components of information handling system 100 communicate with a corresponding device.

In a particular embodiment, BIOS 122 is substantially compliant with one or more revisions of the Unified Extensible Firmware Interface (UEFI) specification. The UEFI specification standard replaces the antiquated personal computer BIOS system found in some older information handling systems. The UEFI specification provides standard interfaces and interoperability guidelines for devices and components that together make up an information handling system. In particular, the UEFI specification provides a standardized architecture and data structures to manage initialization and configuration of devices, booting of platform resources, and passing of control to the operating system. The UEFI specification allows for the extension of platform firmware by loading UEFI driver and UEFI application images. For example, an original equipment manufacturer can include customized or proprietary images to provide enhanced control and management of information handling system 100. While the techniques disclosed herein are described in the context of a UEFI compliant system, one of skill will appreciate that the disclosed systems and methods can be implemented at substantially any information handling system having configurable firmware.

Memory controller 126 represents a portion of a processor complex that is dedicated to the management of the data storage and retrieval from the memory devices of information handling system 100, and the information handling system 100 may include one or more additional memory controllers similar to the memory controller 126, as needed or desired. Memory controller 126 may reside on a system printed circuit board, may be integrated into an I/O processor component, may be integrated with a processor on a system-on-a-chip (SoC), or may be implemented in another way, as needed or desired. Memory controller 126 operates to provide data and control interfaces to one or more DIMMs, such as DIMMs 104, 106, and 108, in accordance with a particular memory architecture. For example, memory controller 126 and the DIMMs 104, 106, and 108 may operate in accordance with a Double-Data Rate (DDR) standard, such as a JEDEC DDR4 or DDR5 standard.

Typically, before any usable memory 134 within DIMMs 104, 106, and 108 may be accessed by OS 124, BIOS 122 performs a POST for information handling system 100. During the POST, BIOS 122 executes MRC 132 to access information associated with DIMMs 104, 106, and 108 and configure a memory address decode register for DIMMs 104, 106, and 108 as will be described herein. In an embodiment, the information associated with DIMMs 104, 106, and 108 stored within the memory address decode register may include, but is not limited to, a mode of operation for DIMMs 104, 106, and 108, and a total amount of memory for the DIMMs, and the like. The mode of operation can be an application-direct mode, a memory mode, a storage mode, or the like. In the application-direct mode, applications executed by processor core 120 via OS 124 directly access data stored within DIMMs 104, 106, and 108. In the memory mode, a DRAM portion of DIMMs 104, 106, and 108 are accessed by processor core 120 of CPU 102 to store data in the DIMMs. In the storage mode, data is accessed in DIMMs 104, 106, and 108 in a block data format. These modes of operation can be set as attributes for DIMMs 104, 106, and 108 by the OS 124, by UEFI environment of BIOS 122, or the like. After the memory address decode register has been configured for DIMMs 104, 106, and 108 and other operations of POST have been completed, BIOS 122 may exit POST and processor core 120 performs one or more runtime operations of OS 124.

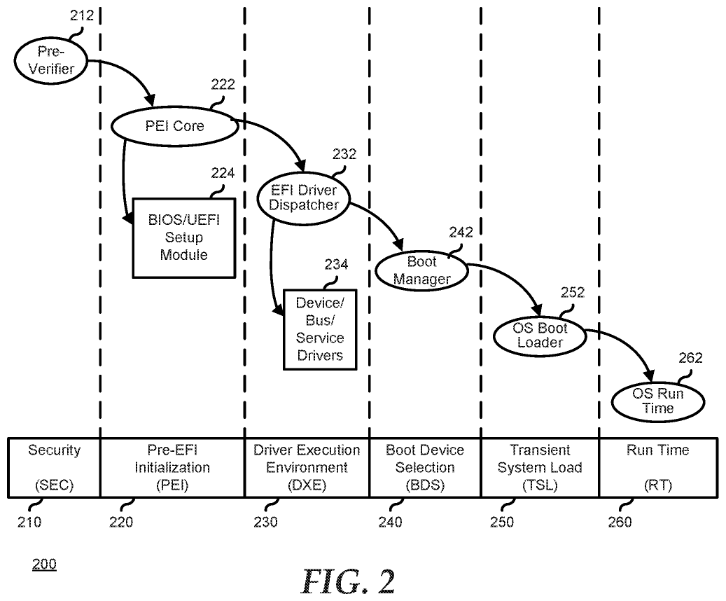

FIG. 2 illustrates a phase diagram 200 for an information handling system that operates using a UEFI, including a security phase (SEC) 210, a pre-EFI initialization phase (PEI) 220, a driver execution environment phase (DXE) 230, a boot device selection phase (BDS) 240, a transient system load phase (TSL) 250, a run time phase (RT) 260, and an afterlife phase (AL) (not shown). SEC 210 is the first phase of a UEFI boot process on the information handling system that operates to set up a pre-verifier 212. Pre-verifier 212 handles all restart events on the information handling system, and temporarily allocates a portion of memory for use during the other boot phases. SEC 210 is executed out of the firmware resident on the information handling system, such as BIOS 122, and so serves as a root of trust for the system. SEC 210 passes execution to PEI 220 which initializes the system memory for the information handling system. PEI 220 includes CPU initialization 224, chipset initialization (not shown), and board resource initialization (not shown).

PEI 220 passes execution to DXE 230 which performs device specific initializations for the information handling system. In particular, DXE 230 executes an EFI driver dispatcher 232 that operates to load device, bus, and service drivers 234. For example, the EFI driver dispatcher 232 may load drivers including, but not limited to, an address range scrubbing (ARS) driver, a block input/output (I/O) driver, and a partition driver. DXE 230 passes execution to BDS 240 to execute a boot manager 242 which identifies a boot target, and passes execution to TSL 250. TSL 250 launches an OS boot loader 252 which loads the operating system, and passes execution to the operating system 262 at RT 260.

Techniques disclosed herein may typically be implemented during DXE 230, and may utilize services provided by the UEFI specification, such as boot services. UEFI applications, including OS loaders, must use boot services functions to access devices and allocate memory. Services are defined by interface functions that may be used by code running in the UEFI environment. Such code may include protocols that manage device access or extend platform capability, as well as applications running in the pre-boot environment, and OS loaders. During boot, system resources are owned by the firmware and are controlled through boot services interface functions. All boot services functionality is available until an OS loader loads enough of its own environment to take control of the system's continued operation and then terminates boot services with a call to ExitBootServices( ).

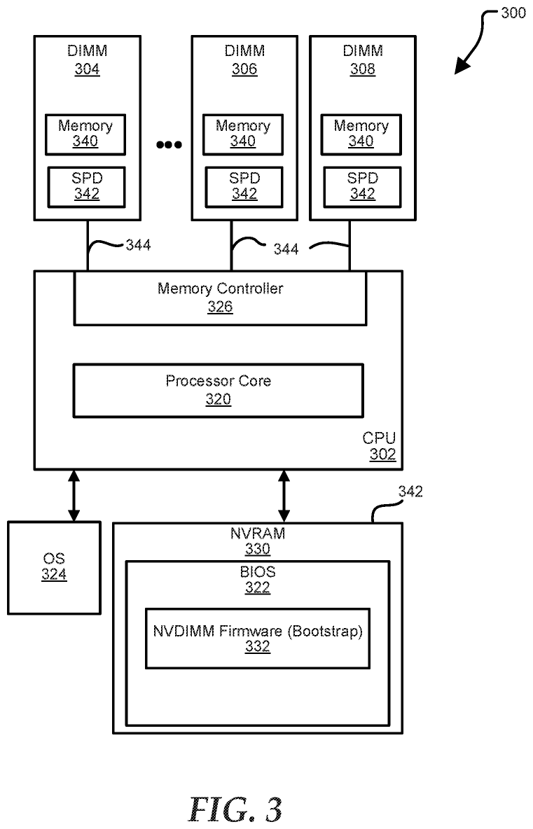

One class of boot services includes protocol handler services, such as LoadImage, StartImage, InstallProtocolInterface, RegisterProtocolNotify, LocateProtocol, and numerous others. A protocol consists of a 128-bit globally unique identifier (GUID) and a Protocol Interface structure. The structure contains the functions and instance data that are used to access a device. The functions that make up Protocol Handler Services allow applications to install a protocol on a handle, identify the handles that support a given protocol, determine whether a handle supports a given protocol, and the like. LoadImage loads an image, such as a device driver, into system memory. StartImage transfers control to a loaded image's entry point. InstallProtocolInterface installs a protocol interface on a device handle. A driver can install multiple protocols. RegisterProtocolNotify registers an event that is to be signaled whenever an interface is installed for a specified protocol. LocateProtocol returns an array of handles that support a specified protocol. During DXE 230, boot services and runtime services can be started and a UEFI boot manager can load UEFI drivers and UEFI applications in an order defined by the global NVRAM variables. Driver initialization includes identifying a driver image that is stored on some type of media, such as at NVRAM 330 of FIG. 3. While the techniques disclosed herein are typically implemented during DXE 230, in another embodiment, these techniques can be implemented using UEFI system management services, such as SmmInstallProtocolInterface, SmmRegisterProtocolNotify, and the like.

FIG. 3 illustrates an information handling system 300 similar to information handling system 100 of FIG. 1, including a CPU 302, dual in-line memory modules (DIMMs) 304, 306, and 308 (DIMMs 304-308), and a non-volatile random access memory (NVRAM) 330. Information handling system 300 may include additional components (not shown), without varying from the scope of this disclosure. CPU 302 includes a processor core 320 and a memory controller 326. CPU 302 may include additional components (not shown), without varying from the scope of this disclosure. CPU 302 is in communication with NVRAM 330, which stores a BIOS 322. CPU 302 executes BIOS 322, and upon completion of the BIOS 322 executes an OS 324.

Each of DIMMs 304, 306, and 308 includes memory 340 and serial presence detect (SPD) data 342. CPU 302 communicates with each of DIMMs 304, 306, and 308 via one or more communication interfaces 344. In an embodiment, each communication interface 344, shown between CPU 302 and DIMM 304, 306, and 308 represents one or more different communication interfaces. In particular, a first portion of communication interface 344 may represent a high-bandwidth data communication interface for communicating data between CPU 302 and memory 340. For example, the high-bandwidth data communication interface may include an interface that operates in accordance with a Double-Data Rate (DDR) standard, such as a JEDEC DDR4 or DDR5 standard. Further, a second portion of communication interface 344 may represent a low-bandwidth data communication interface for communicating data between CPU 302 and SPD data 342. For example, the low-bandwidth data communication interface may include a System Management Bus (SMBus) interface. During a boot process, such as a POST portion of DXE phase 230 of a UEFI boot process, BIOS 322 operates to access SPD data 342 from each of DIMMs 304, 306, and 308 to configure the operations between CPU 320 and the DIMMs. SPD data 342 includes information as to the configuration, capacity, signal timing requirements, and other parameters for the operation between CPU 320 and DIMMs 302, 304, and 306. After BIOS 322 configures the operations between CPU 320 and DIMMs 302, 304, and 306, the CPU can communicate with memory 340 in the DIMMs directly via the high-bandwidth communication interface.

In a particular embodiment, one or more of DIMMs 302, 304, and 306 represents a NVDIMM such as an Intel Optane DC Persistent Memory Module (DCPMM) DIMM. Here, a portion of memory 340 is reserved for various functions that are related to how the NVDIMM is to be utilized in information handling system 300. For example, BIOS 322 can store information related to the memory mode (e.g., application-direct mode, memory mode, storage mode) in which to operate the NVDIMM, to namespaces instantiated on the NVDIMM, or the like. Here, the information can be stored on different partitions of memory 340 that are restricted from access by the CPU under the control of OS 324. That is, the partitions may represent memory regions of memory 340 that are reserved to the use of BIOS 322.

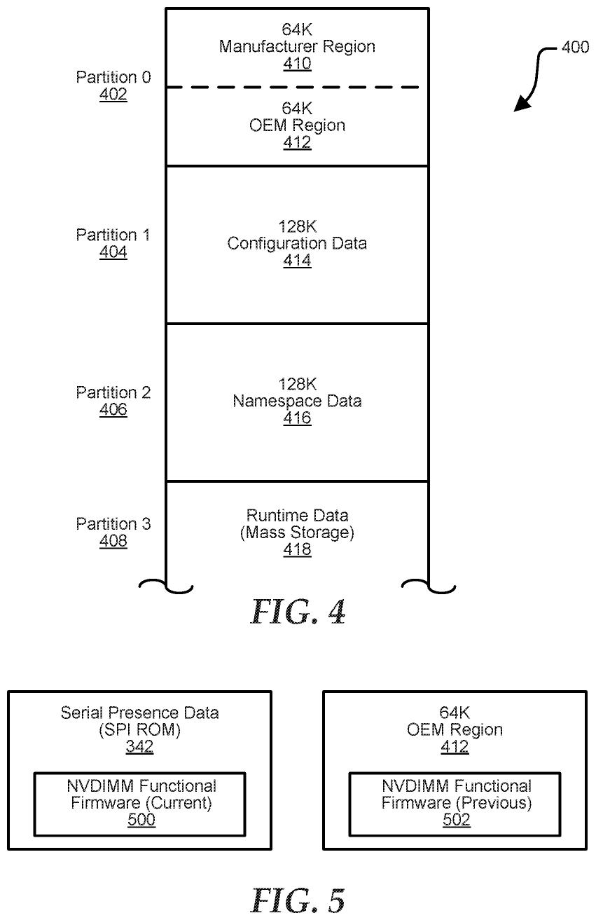

FIG. 4 illustrates a partition map 400 of a NVDIMM, such as an Intel Optane DC Persistent Memory Module (DCPMM) DIMM. Partition map 400 includes partitions 402, 404, 406, and 408. Partition 402 is a 128 kilobyte (KB) partition that includes a 64 KB region 410 that is reserved for information stored by a manufacturer of the NVDIMM, for example, for Intel proprietary information related to the configuration of the NVDIMM. Partition 402 also includes a 64 KB region 412, referred to hereinafter as OEM region 412, that is accessible to an original equipment manufacturer (OEM) for storage of information that is at the OEMs discretion. It will be understood that OEM region 412 may be utilized as a reserved 64 MB region that is configured in a Persistent Memory App-Direct mode. Various embodiments information to be stored in OEM region 412 will be described further below. Partition 404 is a 128 KB partition that includes a configuration data segment 414. Partition 406 is a 128 KB partition that includes namespace data for one or more NVDIMMs that are configured in the storage mode. Partition 408 represents the bulk of the data storage capacity of the DIMM that is usable in the selected mode by the information handling system for data storage.

In a particular embodiment, an NVDIMM is operated utilizing firmware that is stored in two parts: on the BIOS ROM of the information handling system, and on the particular NVDIMM. The component of the firmware that resides on the BIOS ROM operates to initialize the NVDIMM and to provide an interface between the information handling system and the NVDIMM. The component of the NVDIMM firmware that resides on the particular NVDIMM, referred to as functional firmware, operates to manage the interface between the memory channel from the memory controller and the storage media of the NVDIMM, and to implement various policy and configuration options on the NVDIMM. The functional firmware is typically stored on a persistent storage media such as a Serial Presence Interface (SPI) ROM.

In a particular embodiment, the flash media of a NVDIMM-N type NVDIMM is configured to store not only a present version of the functional firmware, but also to store a manufacturer version of the functional firmware which is non-updateable. Here, when new functional firmware is to be installed to the NVDIMM-N, a BIOS or a firmware update program operates to store the new functional firmware version image to the location in the flash media that stores the current functional firmware, and the BIOS or firmware update program then directs the NVDIMM-N to access the new functional firmware version. In this way, if the write operation to store the new functional firmware version fails, the NVDIMM-N bootstrap firmware stored on the flash media can default to run the NVDIMM-N from the manufacturer functional firmware version.

In another embodiment, such as when the NVDIMM is a DCPMM, while the SPI ROM is configured to store the present version of the functional firmware, the SPI ROM is not configured to store the past version of the functional firmware. Here, when a BIOS or firmware update program performs a failing write operation to store the new functional firmware version to the SPI ROM, the NVDIMM will not have a previously “good” version of the functional firmware to rely on, and the storage media may become inaccessible due to the write failure.

In a particular embodiment, a NVDIMM stores a copy of a previous version of the NVDIMM functional firmware in its OEM region of the NVDIMM memory to facilitate the recovery from a failing write operation to store a new functional firmware version to the SPI ROM. Here, the OEM region will be understood to include a reserved 64 MB of persistent memory configured in the App-Direct mode. FIG. 5 illustrates flash memory such as an SPI ROM of information handling system 300, and OEM region 412 in an embodiment of the present disclosure. The flash memory includes an image of a current version of the NVDIMM functional firmware 500, and OEM region 412 includes an image of a previous version of the functional firmware 502. Here, when the BIOS or firmware update program is utilized to update the functional firmware on an NVDIMM, the new functional firmware is written to the SPI ROM in accordance with the typical firmware update process. In a first case, before writing the new functional firmware to the SPI ROM, the BIOS or firmware update program reads the current version of the functional firmware from the SPD data and writes it to OEM region 412. Here, on a next system boot process, the BIOS can determine if the new version of the functional firmware that is in the SPI ROM is operating as expected. If so, the functional firmware in the SPI ROM is marked as valid, and the boot process continues. If the new version of the functional firmware that is in the SPI ROM is not operating as expected, the BIOS can invoke the firmware update process or the firmware update program to restore the version of the functional firmware from OEM region 412 back to the SPI ROM to restore the previous functionality. In another case, the BIOS or firmware update program writes both the previous version of the functional firmware and the new version of the functional firmware to OEM region 412. Here, on a next system boot process, if the BIOS determines that the new version of the functional firmware that is in the SPI ROM is not operating as expected, the BIOS can invoke the firmware update process or the firmware update program to retry the write of the new version of the functional firmware before restoring the version of the functional firmware from OEM region 412 back to the SPI ROM to restore the previous functionality.

In another embodiment, such as when two or more NVDIMMs is a DCPMM, a BIOS may be required to maintain all NVDIMMs at a particular NVDIMM functional firmware version level or higher, otherwise the memory configuration will be deemed to be unsupported, and the NVDIMMs may not be initialized. This may be required of a BIOS in order to ensure compatible interoperation between the NVDIMMs. In a particular embodiment, when the BIOS boots the system, the BIOS checks the NVDIMM functional firmware versions of each NVDIMM in the system to ensure that they are all operating with compatible versions. If so, the BIOS proceeds with the boot process. However, if the NVDIMM functional firmware versions are not compatible, then the BIOS reads the NVDIMM functional firmware 502 from the NVDIMM with the newest version of the functional firmware, and initiates the firmware update process or calls the firmware update program to update the other NVDIMMs to the newest functional firmware version.

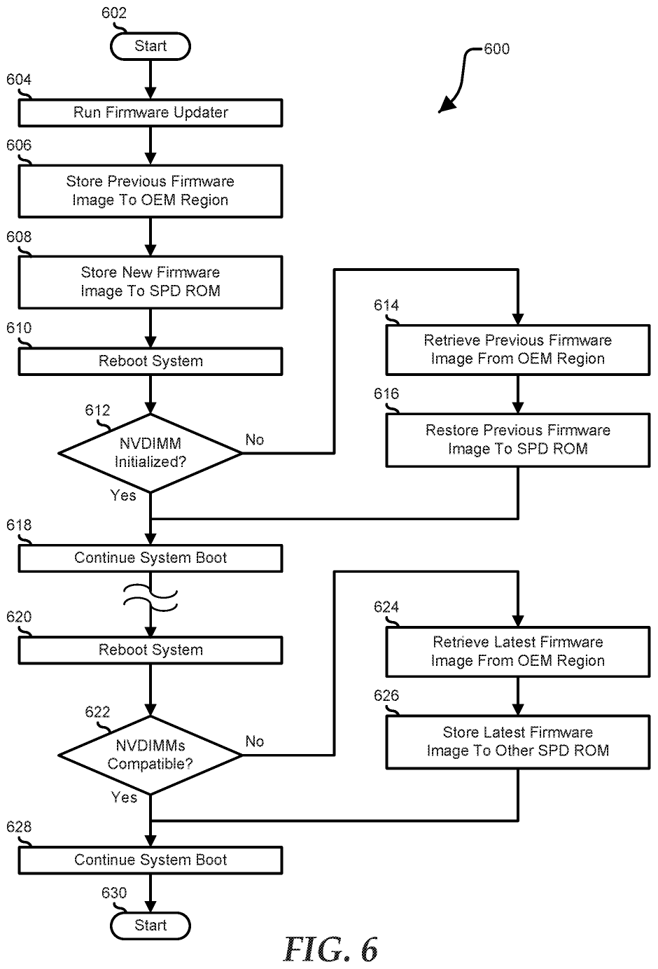

FIG. 6 is a flow diagram illustrating a method 600 for restoring a previously functional firmware image on a NVDIMM, such as an Intel Optane DCPMM, starting at block 602. It will be readily appreciated that not every method step set forth in this flow diagram is always necessary, and that certain steps of the methods can be combined, performed simultaneously, in a different order, or perhaps omitted, without varying from the scope of the disclosure. At block 604, a NVDIMM functional firmware updater is run from a BIOS ROM on an information handling system. For example, the NVDIMM functional firmware updater may be a functional firmware update process of a system BIOS, or may be a stand-alone functional firmware update program. A previous version of the functional firmware for a NVDIMM is read from the SPI ROM of the NVDIMM and stored to the OEM region of the NVDIMM in block 606, and a new version of the functional firmware for the NVDIMM is stored to the SPI ROM in block 608. The BIOS reboots the information handling system in block 610. A decision is made as to whether or not the NVDIMM is properly initialized in decision block 612. For example, as a portion of the reboot process, the BIOS can operate to determine whether the updated NVDIMM is initialized properly and is operating as expected. If the NVDIMM is properly initialized, the “YES” branch of decision block 612 is taken and the boot process is continued in block 618. If the NVDIMM is not initialized properly, the “NO” branch of decision block 612 is taken, the previous version of the functional firmware is read from the OEM region of the NVDIMM in block 614, the previous version of the functional firmware is restored to the SPI ROM in block 616, and the method proceeds to block 618 where the boot process is continued. Here, it may be understood that a system reboot may need to occur in order to initialize the NVDIMM with the previous version of the functional firmware after restoring the previous version of the functional firmware to the SPI ROM of the NVDIMM, as needed or desired.

After an elapsed time, the information handling system is rebooted in block 620, and a decision is made as to whether or not all of the NVDIMMs installed in the information handling system are compatible in decision block 622. For example, as a portion of the reboot process, the BIOS can operate to determine whether all of the installed NVDIMMs have compatible versions of functional firmware. If all of the NVDIMMs are compatible, the “YES” branch of decision block 622 is taken, the boot process is continued in block 628, and the method ends in block 630. If all of the NVDIMMs are not compatible, the “NO” branch of decision block 622 is taken, the latest version of the functional firmware is read from the OEM region of the particular NVDIMM that includes the latest version in block 624, the latest version of the functional firmware is stored to the SPI ROMs of the NVDIMMs without the latest version of the functional firmware in block 626, and the method proceeds to block 628 where the boot process is continued. Here, it may be understood that a system reboot may need to occur in order to initialize the NVDIMMs with the latest version of the functional firmware after storing the latest version of the functional firmware to the SPI ROMs of the NVDIMM, as needed or desired.

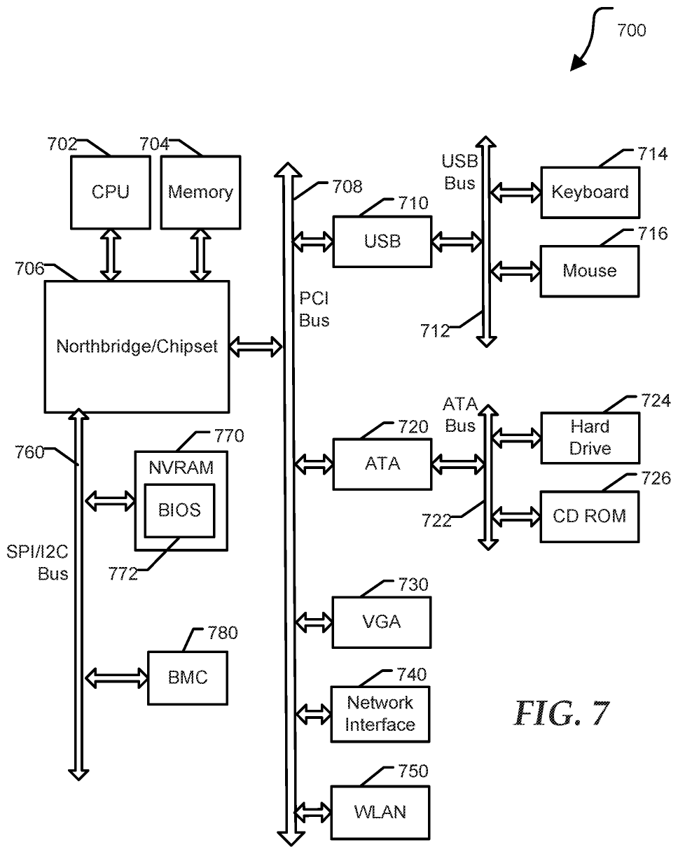

FIG. 7 illustrates a general information handling system 700 including a processor 702, a memory 704, a northbridge/chipset 706, a PCI bus 708, a universal serial bus (USB) controller 710, a USB 712, a keyboard device controller 714, a mouse device controller 716, a configuration an ATA bus controller 720, an ATA bus 722, a hard drive device controller 724, a compact disk read only memory (CD ROM) device controller 726, a video graphics array (VGA) device controller 730, a network interface controller (NIC) 740, a wireless local area network (WLAN) controller 750, a serial peripheral interface (SPI) bus 760, a NVRAM 770 for storing BIOS 772, and a baseboard management controller (BMC) 780. In an embodiment, information handling system 700 may be information handling system 100 of FIG. 1 and/or information handling system 300 of FIG. 3. BMC 780 can be referred to as a service processor or embedded controller (EC). Capabilities and functions provided by BMC 780 can vary considerably based on the type of information handling system. For example, the term baseboard management system is often used to describe an embedded processor included at a server, while an embedded controller is more likely to be found in a consumer-level device. As disclosed herein, BMC 780 represents a processing device different from CPU 702, which provides various management functions for information handling system 700. For example, an embedded controller may be responsible for power management, cooling management, and the like. An embedded controller included at a data storage system can be referred to as a storage enclosure processor.

For purpose of this disclosure information handling system 700 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 700 can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, information handling system 700 can include processing resources for executing machine-executable code, such as CPU 702, a programmable logic array (PLA), an embedded device such as a System-on-a-Chip (SoC), or other control logic hardware. Information handling system 700 can also include one or more computer-readable medium for storing machine-executable code, such as software or data.

System 700 can include additional processors that are configured to provide localized or specific control functions, such as a battery management controller. Bus 760 can include one or more busses, including a SPI bus, an I2C bus, a system management bus (SMBUS), a power management bus (PMBUS), and the like. BMC 780 can be configured to provide out-of-band access to devices at information handling system 700. As used herein, out-of-band access herein refers to operations performed prior to execution of BIOS 772 by processor 702 to initialize operation of system 700.

BIOS 772 can be referred to as a firmware image, and the term BIOS is herein used interchangeably with the term firmware image, or simply firmware. BIOS 772 includes instructions executable by CPU 702 to initialize and test the hardware components of system 700, and to load a boot loader or an operating system (OS) from a mass storage device. BIOS 772 additionally provides an abstraction layer for the hardware, such as a consistent way for application programs and operating systems to interact with the keyboard, display, and other input/output devices. When power is first applied to information handling system 700, the system begins a sequence of initialization procedures. During the initialization sequence, also referred to as a boot sequence, components of system 700 are configured and enabled for operation, and device drivers can be installed. Device drivers provide an interface through which other components of the system 700 can communicate with a corresponding device.

Information handling system 700 can include additional components and additional busses, not shown for clarity. For example, system 700 can include multiple processor cores, audio devices, and the like. While a particular arrangement of bus technologies and interconnections is illustrated for the purpose of example, one of skill will appreciate that the techniques disclosed herein are applicable to other system architectures. System 700 can include multiple CPUs and redundant bus controllers. One or more components can be integrated together. For example, portions of northbridge/chipset 706 can be integrated within CPU 702. Additional components of information handling system 700 can include one or more storage devices that can store machine-executable code, one or more communications ports for communicating with external devices, and various input and output (I/O) devices, such as a keyboard, a mouse, and a video display. For example, device controller 730 may provide data to a display device 790 to visually present the information to an individual associated with information handling system 700. An example of information handling system 700 includes a multi-tenant chassis system where groups of tenants (users) share a common chassis, and each of the tenants has a unique set of resources assigned to them. The resources can include blade servers of the chassis, input/output (I/O) modules, Peripheral Component Interconnect-Express (PCIe) cards, storage controllers, and the like.

Information handling system 700 can include a set of instructions that can be executed to cause the information handling system to perform any one or more of the methods or computer based functions disclosed herein. The information handling system 700 may operate as a standalone device or may be connected to other computer systems or peripheral devices, such as by a network.

In a networked deployment, the information handling system 700 may operate in the capacity of a server or as a client user computer in a server-client user network environment, or as a peer computer system in a peer-to-peer (or distributed) network environment. The information handling system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single information handling system 700 is illustrated, the term “system” shall also be taken to include any collection of systems or sub-systems that individually or jointly execute a set, or multiple sets, of instructions to perform one or more computer functions.

The information handling system 700 can include a disk drive unit and may include a computer-readable medium, not shown in FIG. 7, in which one or more sets of instructions, such as software, can be embedded. Further, the instructions may embody one or more of the methods or logic as described herein. In a particular embodiment, the instructions may reside completely, or at least partially, within system memory 704 or another memory included at system 700, and/or within the processor 702 during execution by the information handling system 700. The system memory 704 and the processor 702 also may include computer-readable media.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a processor or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system, comprising:
a first non-volatile dual in-line memory module (NVDIMM) including a first Serial Presence Interface (SPI) read only memory (ROM) device, and a first non-volatile memory device; and
a processor configured to execute a firmware updater to:
store a first firmware image for the first NVDIMM to the first SPI ROM device; and
store the first firmware image to the first non-volatile memory device.

2. The information handling system of claim 1, wherein the processor is further configured to execute the firmware updater to:
receive a second firmware image for the first NVDIMM, wherein the second firmware image is a newer firmware image than the first firmware image;
store the second firmware image to the first SPI ROM device;

3. The information handling system of claim 2, wherein the processor is further configured to execute the firmware updater to:
reboot the information handling system:
determine whether or not the first NVDIMM was initialized in during the reboot of the information handling system:
retrieve the first firmware image from the first non-volatile memory device when the first NVDIMM was not initialized in during the reboot; and
restore the first firmware image to the first SPI ROM device in response to retrieving the first firmware image from the first non-volatile memory device.

4. The information handling system of claim 1, further comprising:
a second NVDIMM including a second SPI ROM device, and a second non-volatile memory device, wherein the second SPI ROM device stores a second firmware image for the second NVDIMM;
wherein the processor is further configured to:
determine whether or not the first NVDIMM and the second NVDIMM are compatible based upon the first and second firmware images.

5. The information handling system of claim 4, wherein in determining whether or not the first NVDIMM and the second NVDIMM are compatible, the processor is further configured to:
determine a first revision level of the first firmware image; and
determine a second revision level of the second firmware image, wherein the first second NVDIMMs are determined to be compatible when the first revision level is the same as the second revision level.

6. The information handling system of claim 5, wherein the first and second NVDIMMs are determined to not be compatible when the first revision level is a later revision level than the second revision level.

7. The information handling system of claim 6, wherein, when the first and second NVDIMMs are not compatible, the processor is further configured to:
retrieve the first firmware image from the first non-volatile memory device;
store the first firmware image to the second SPI ROM device; and
store the first firmware image to the second non-volatile memory device.

8. The information handling system of claim 1, wherein the firmware updater comprises one of a Basic Input/Output System (BIOS) of the information handling system, and a firmware update program.

9. The information handling system of claim 1, wherein the first NVDIMM is a DC Persistent Memory Module (DCPMM).

10. A method, comprising:
storing, by a processor of an information handling system, a first firmware image for a first a non-volatile dual in-line memory module (NVDIMM) on a first Serial Presence Interface (SPI) read only memory (ROM) device of the NVDIMM; and
storing, by the processor, the first firmware image on a first non-volatile memory device of the NVDIMM.

11. The method of claim 10, further comprising:
receiving, by the processor, a second firmware image for the first NVDIMM, wherein the second firmware image is a newer firmware image than the first firmware image;
storing, by the processor, the second firmware image to the SPI ROM device;

12. The method of claim 10, further comprising:
rebooting, by the processor, the information handling system:
determining, by the processor, whether or not the first NVDIMM was initialized in during the reboot of the information handling system:
retrieving, by the processor, the first firmware image from the first non-volatile memory device when the first NVDIMM was not initialized in during the reboot; and
restoring, by the processor, the first firmware image to the first SPI ROM device in response to retrieving the first firmware image from the first non-volatile memory device.

13. The method of claim 10, further comprising:
determining, by the processor, whether or not the first NVDIMM and a second NVDIMM are compatible, wherein the second NVDIMM includes a second SPI ROM device, and a second non-volatile memory device, wherein the second SPI ROM device stores a second firmware image for the second NVDIMM, and wherein determining whether or not the first NVDIMM and a second NVDIMM are compatible is based upon the first and second firmware images.

14. The method of claim 13, wherein in determining whether or not the first NVDIMM and the second NVDIMM are compatible, the method further comprises:
determining a first revision level of the first firmware image; and
determining a second revision level of the second firmware image, wherein the first second NVDIMMs are determined to be compatible when the first revision level is the same as the second revision level.

15. The method of claim 14, wherein the first and second NVDIMMs are determined to not be compatible when the first revision level is a later revision level than the second revision level.

16. The method of claim 15, wherein, when the first and second NVDIMMs are not compatible, the method further comprises:
retrieving, by the processor, the first firmware image from the first non-volatile memory device;
storing, by the processor, the first firmware image to the second SPI ROM device; and
storing, by the processor, the first firmware image to the second non-volatile memory device.

17. The method of claim 15, wherein the first NVDIMM is a DC Persistent Memory Module (DCPMM).

18. An information handling system, comprising:
a first DC persistent memory module (DCPMM) including a first Serial Presence Interface (SPI) read only memory (ROM) device, and a first non-volatile memory device; and
a processor configured to execute a firmware updater to:
store a first firmware image for the first DCPMM to the first SPI ROM device;
store the first firmware image to the first non-volatile memory device;
receive a second firmware image for the first DCPMM, wherein the second firmware image is a newer firmware image than the first firmware image; and
store the second firmware image to the first SPI ROM device.

19. The information handling system of claim 18, wherein the processor is further configured to execute the firmware updater to:
reboot the information handling system:
determine whether or not the first DCPMM was initialized in during the reboot of the information handling system:
retrieve the first firmware image from the first non-volatile memory device when the first DCPMM was not initialized in during the reboot; and
restore the first firmware image to the first SPI ROM device in response to retrieving the first firmware image from the first non-volatile memory device.

20. The information handling system of claim 18, further comprising:
a second DCPMM including a second SPI ROM device, and a second non-volatile memory device, wherein the second SPI ROM device stores a second firmware image for the second DCPMM;
wherein the processor is further configured to:
determine whether or not the first DCPMM and the second DCPMM are compatible based upon the first and second firmware images.
